(19) United States
(12) Patent Application Publication
(10) Pub. No.: US 2017/0005388 A1
(43) Pub. Date: Jan. 5, 2017

(54) PHASE SHIFTER

(71) Applicants: Yu-Chia HSU, Taichung City (TW); Kuang-Wei Lin, Taichung City (TW)

(72) Inventors: Yu-Chia HSU, Taichung City (TW); Kuang-Wei Lin, Taichung City (TW)

(73) Assignee: WHA YU INDUSTRIAL CO., LTD., Hsinchu City (TW)

(21) Appl. No.: 14/789,107

(22) Filed: Jul. 1, 2015

(51) Int. Cl. H01P 1/18

(52) U.S. Cl. CPC H01P 1/184

(57) ABSTRACT

A phase shifter includes: a feed layer; a stripline feeding network as strip conductor fixed to a circuit layout surface, the stripline feeding network having a phase shifting unit, including two fixed transmission line sections, and a trimmer with stripline conductor, including an acting surface facially opposite to the phase shifting unit, the stripline conductor is located in the acting surface in strip shape, and the stripline conductor and the two fixed transmission line sections of phase shifting unit are in electrical transport relationship, the electrical transmission length between line sections can be adjusted by the shift of stripline conductor to implement phase shift function; an interlocking bar, in displacement actuation state located at the gap on the circuit layout surface of feed layer, the interlocking bar drives the trimmer to shift; a metal layer, located in the corresponding position of at least a back side of feed layer.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a phase shifter, and more particularly to an innovative structure type disclosure integrated with a stripline feeding network and a trimmer with stripline conductor.

2. Description of Related Art Including Information Disclosed Under 37 CFR 1.97 and 37 CFR 1.98.

The phase shifter is a device which adjusts the phase of an electric wave, and it moves the phase of signal for an angle. However, the actuation mode of the phase shifter varies with the product structure type.

The phase shifter is integrated into array antenna structures extensively, and different radiators in an antenna element can feed in signals of different phases by the adjustment of the phase shifter, so as to radiate beams in different directions in space.

A prior art type of phase shifter is shown in FIG. 1. Paired spaced phase shifter subunits 06 are mounted on the external surface of a metallic reflecting plate 05. Said phase shifter subunit 06 is usually a three-dimensional salient mechanical scalable adjusting mechanism. A power divider 07 made of a circuit board is independently mounted on the external surface of the metallic reflecting plate 05. Said power divider 07 and phase shifter subunits 06 are connected by multiple conducting wires 08 to reach the preset electrical transport state.

However, the prior art phase shifter structure still has the following problems: as the feeding network complexity of the known phase shifter is too high, there are too many and scattered components of stripline components, phase shifter subunits and power dividers, so that the difficulty in the assembly of the phase shifter is increased, the assembly yield of wires and components decreases relatively (note: poor stripline soldering is likely to degrade characteristics and result in high difficulty in debugging), and the manufacturing cost is increased.

Thus, to overcome said problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The “phase shifter” disclosed by the present invention is an innovative unique structure type and has the technical characteristic of being formed of said feed layer, the stripline feeding network with phase shifting unit and power distribution unit, trimmer with stripline conductor, interlocking bar and metal layer, compared with the known structure disclosed in the “Description of Related Art”, as the stripline feeding network integrates the phase shifting unit into the same stripline structure, many cable conductor layout and welding procedures can be reduced compared with the known structure, so as to simplify the structure type of phase shifter feeding network greatly, the stripline welding positions can be reduced greatly, the phase shifting unit and power distribution unit can be integrated into the same stripline feeding network structure, so that the overall phase shifter has practical advancement and better industrial economy, such as easier assembly, higher assembly yield and lower manufacturing cost.

On the other hand, in terms of the phase shift function of the present invention, the trimmer of the stripline conductor slides on the phase shifting unit for the stripline feeding network facially, the phase shift function is implemented by changing the electrical transmission length between two fixed transmission line sections, and the structure type and phase shift system of the present invention can attain practical advantages and advancement of a durable structure and stable and accurate adjustment.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a plan view of a known phase shifter.

FIG. 2 is an exploded view of major components of the preferred embodiment of the present invention.

FIG. 3 is a close-up view of FIG. 2.

FIG. 4 is an exploded view of detailed components of the preferred embodiment of the present invention.

FIG. 5 is a stereogram from the viewing angle of the trimmer acting surface of the present invention.

FIG. 6 is a schematic diagram I of the actuating state of the present invention.

FIG. 7 is a schematic diagram II of the actuating state of the present invention.

FIG. 8 is a longitudinal section view of the preferred embodiment of the present invention.

FIG. 9 is a longitudinal section view of another embodiment of the present invention.

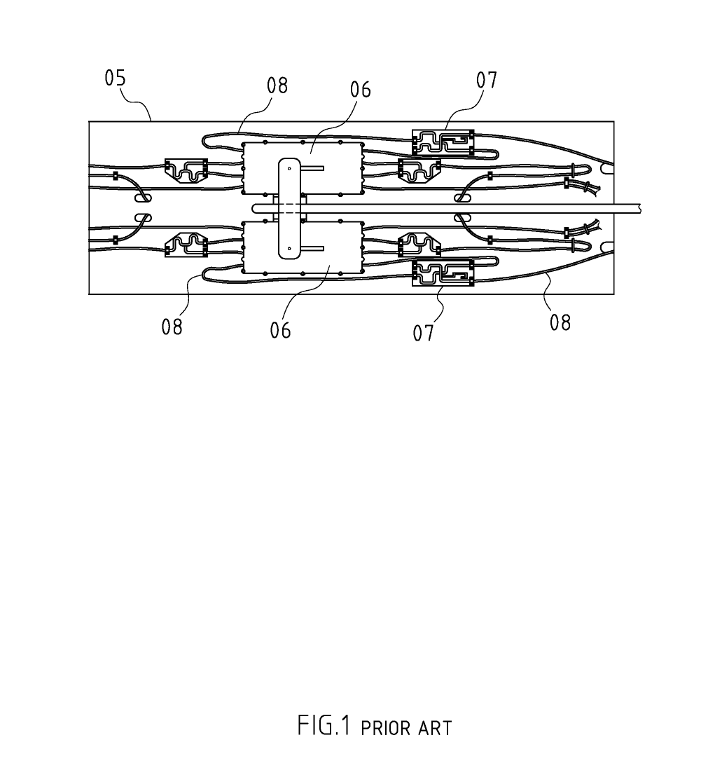

### DETAILED DESCRIPTION OF THE INVENTION

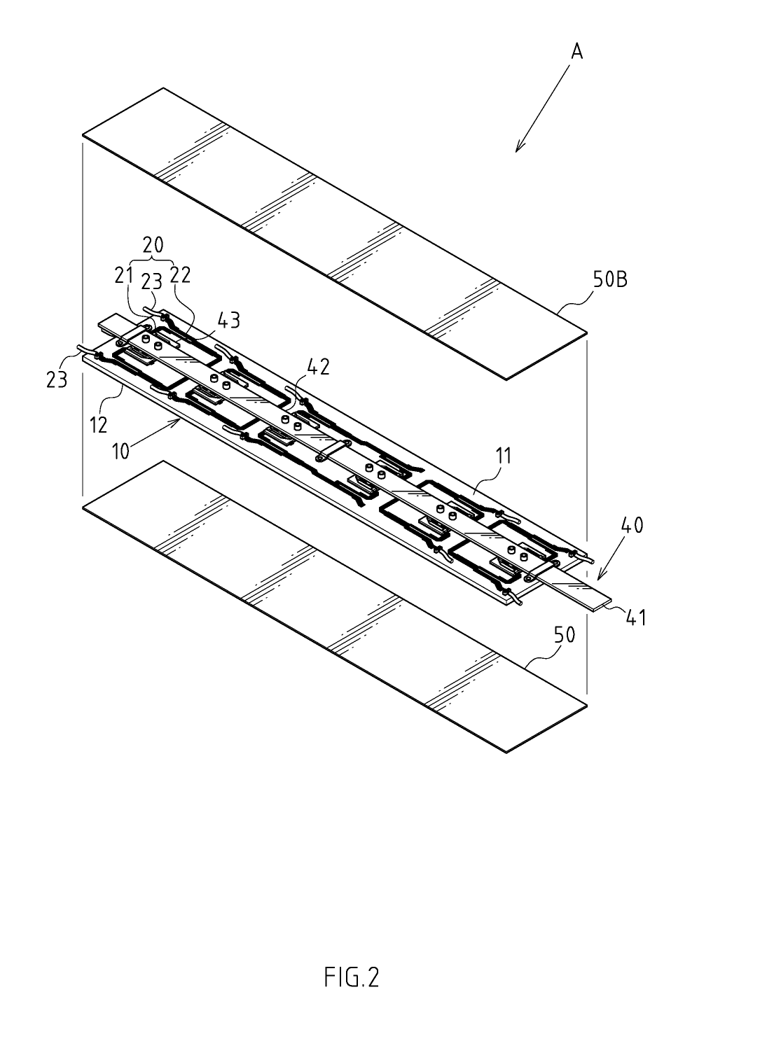

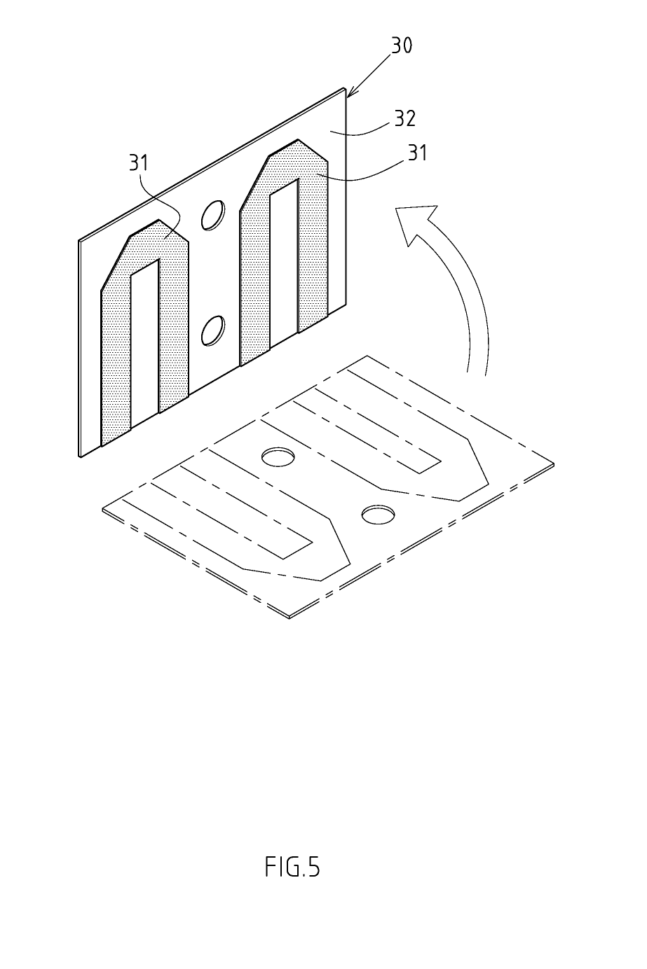

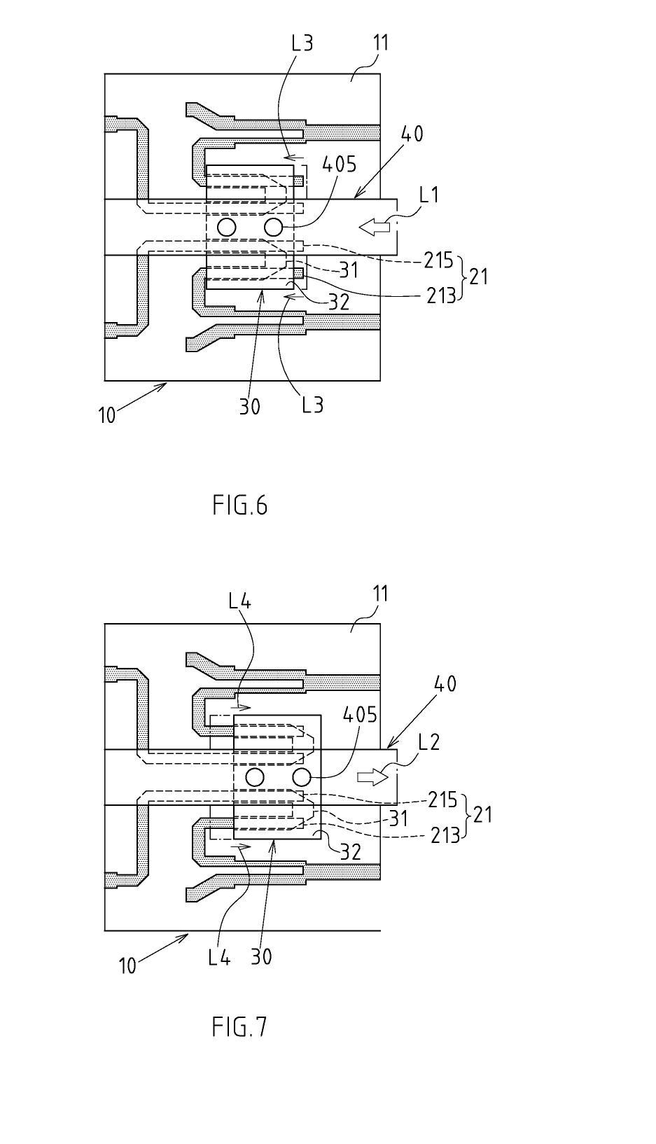

Referring to FIGS. 2 to 5, the preferred embodiment of the phase shifter of the present invention is shown. This embodiment is for illustration purposes only. The phase shifter A comprises a feed layer 10, formed of an insulator, with a circuit layout surface 11 and a back side 12. A stripline feeding network 20 is provided as a strip conductor fixed to the circuit layout surface 11 of feed layer 10. The stripline feeding network 20 consists of at least one phase shifting unit 21 (note: this embodiment is multiple pairwise layout), formed of two fixed transmission line sections 213, 215. There is an open part 217 between two ends of the two fixed transmission line sections 213, 215, and the fixed transmission line sections 213, 215 are disconnected. At least one power distribution unit 22 is provided, which is forked and electrically connected to phase shifting unit 21, and one fork end of power distribution unit 22 is electrically connected to a feed line 23. At least one trimmer 30 with stripline conductor 31 is provided, said trimmer 30 is made of insulating material, including an acting surface 32 opposite to the phase shifting unit 21. The stripline conductor 31 is located in the acting surface 32 in strip shape (as shown in FIG. 5), and there is electrical transport between the stripline conductor 31 and the two fixed transmission line sections 213, 215 of phase shifting unit 21 (as shown in FIG. 6). The electric transmission length between two fixed transmission line sections 213, 215 can be changed by shift control of the stripline conductor 31, so as to shift the phase. At least one interlocking bar 40 is provided in a displacement actuation state located in the gap on circuit layout surface 11 of feed layer 10, the interlocking bar 40 consists of a driven end 41 and an interlocking section 42, the interlocking section 42 has at least an assembling part 43 for setting the trimmer 30, and the interlocking bar 40 drives the trimmer 30 to shift. At least one metal layer 50, 50B is located in corresponding position of the back side 12 of feed layer 10.

According to the structural composition design, the phase shift system and actuation of phase shifter A disclosed by the present invention are shown in FIGS. 6 and 7. The push-and-pull action of interlocking bar 40 (see Arrow L1 in FIG. 6 and Arrow L2 in FIG. 7) drives the synchronous forward-backward displacement of trimmer 30 (see Arrow L3 in FIG. 6 and Arrow L4 in FIG. 7). In this actuation process, due to the electrical transport between the stripline conductor 31 on the acting surface 32 of trimmer 30 and the two fixed transmission line sections 213, 215 of phase shifting unit 21, the originally disconnected two fixed transmission line sections 213, 215 are electrically connected as bridged by stripline conductor 31, and the electrical transmission length between two fixed transmission line sections 213, 215 is changed by the displacement of the stripline conductor 31. The larger the coverage area of the stripline conductor 31 is, the longer is the overlap length, the shorter the electrical transmission distance is, the smaller is the phase shift amount, so as to adjust the phase shift.

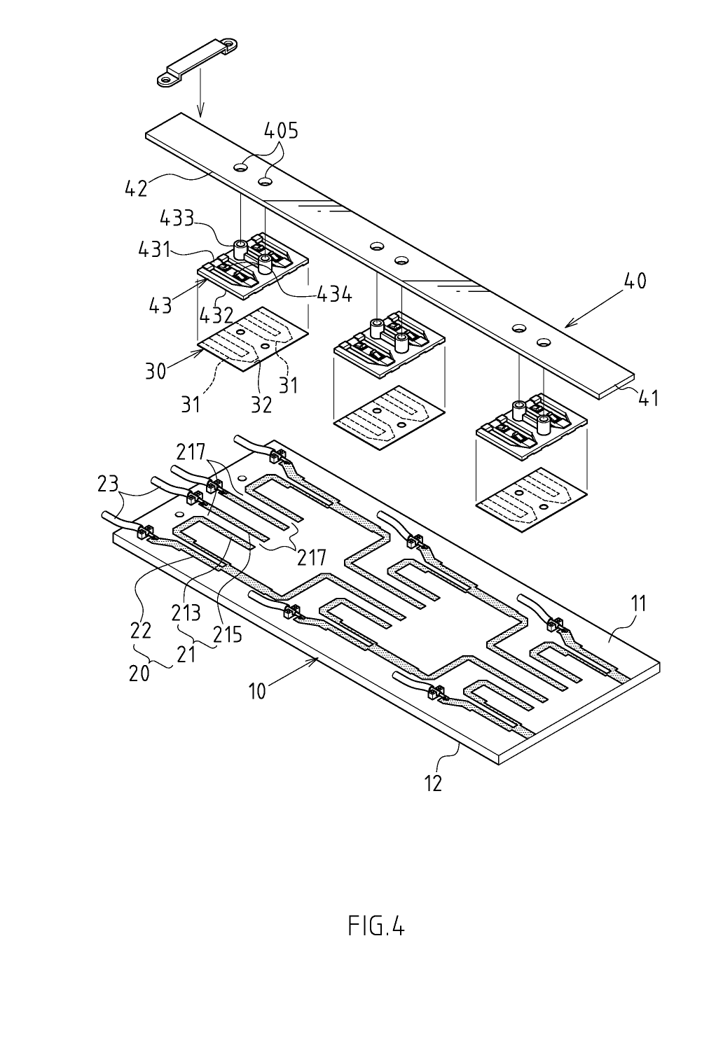

As shown in FIG. 4, the stripline conductor 31 can be U shaped. This shape is a preferred embodiment, but the present invention should not be limited to this.

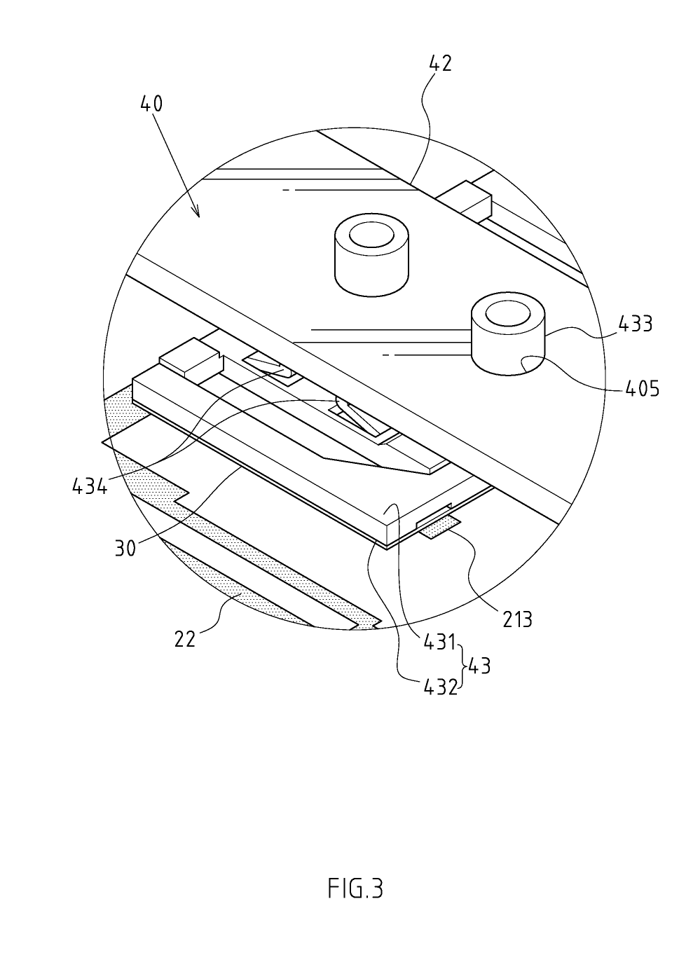

As shown in FIG. 3, the assembling part 43 for the interlocking section 42 of the interlocking bar 40 can be a bench insulator. The assembling part 43 has a top surface 431 leaning against the interlocking bar 40 and a bottom surface 432 for locating trimmer 30. There is a location column 433 protruding from the top surface 431, and there is a corresponding location hole 405 in the interlocking bar 40. There is an elastic top bracing part 434 at the spacing between the top surface 431 and the location column 433. The elastic top bracing part 434 leans against the interlocking bar 40 elastically (as shown in FIG. 3), so as to press down the assembling part 43 elastically.

The stripline conductor 31 and the two fixed transmission line sections 213, 215 of the phase shifting unit 21 are in electrical transport relationship by contacting each other.

There is an electrical transport relationship of spaced coupling between the stripline conductor 31 and two fixed transmission line sections 213, 215 of the phase shifting unit 21, and the spacer medium in the spaced coupling position can be air, or insulating material (e.g. PP, PE, POM).

The stripline feeding network 20 is formed of sheet metal fixed to the circuit layout surface 11 of feed layer 10.

The feed layer 10 can be printed circuit board, and the stripline feeding network 20 is formed by etching.

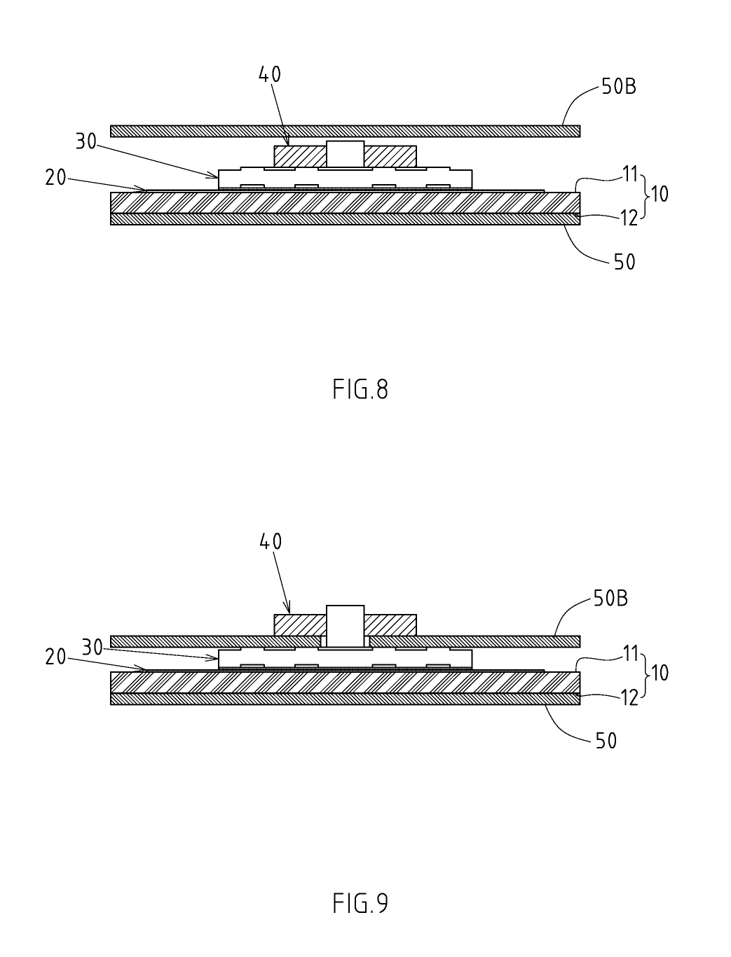

As shown in FIGS. 2 and 8, said metal layers 50, 50B can be located in the corresponding position of the back side 12 of feed layer 10 and in the corresponding position of circuit layout surface 11.

Afterwards, in terms of said structure type with two metal layers 50, 50B, the interlocking bar 40 can be implemented under the metal layer 50B on the circuit layout surface 11 (as shown in FIG. 8), and FIG. 9 shows the interlocking bar 40 implemented above the metal layer 50B.

We claim:

1. A phase shifter, including:
a feed layer, formed of insulator, with a circuit layout surface and a back side;
a stripline feeding network, as strip conductor fixed to the circuit layout surface of feed layer, the stripline feeding network has:
at least one phase shifting unit, formed of spaced two fixed transmission line sections;
an open part between the two ends of the two fixed transmission line sections, the two fixed transmission line sections are disconnected;
at least one power distribution unit, forked and electrically connected to the phase shifting unit, one fork end of the power distribution unit is electrically connected to a feed line;
at least one trimmer with a stripline conductor, said trimmer is made of insulating material, including an acting surface facially opposite to the phase shifting unit, the stripline conductor is located in the acting surface in strip shape, and there is an electrical transport relationship between the stripline conductor and two fixed transmission line sections of phase shifting unit, the electrical transmission length between two fixed transmission line sections can be changed by the shift control of stripline conductor, so as to implement phase shift function;
at least one interlocking bar, including a driven end and an interlocking section; the interlocking section has at least one assembling part for locating the trimmer, the interlocking bar drives the trimmer to shift;
at least one metal layer, located in the corresponding position of at least back side of feed layer.

2. The structure defined in claim 1, wherein the stripline conductor is U-shaped.

3. The structure defined in claim 2, wherein the assembling part for the interlocking section of the interlocking bar is a bench insulator, the assembling part has a top surface leaning against the interlocking bar and a bottom surface for locating trimmer, and there is a location column protruding from the top surface, the interlocking bar has a corresponding location hole, there is an elastic top bracing part at the spacing between the top surface and the location column, the elastic top bracing part leans against the interlocking bar elastically, so as to press down the assembling part elastically.

4. The structure defined in claim 3, wherein the stripline conductor and the two fixed transmission line sections of phase shifting unit are in electrical transport relationship by contacting each other.

5. The structure defined in claim 3, wherein the stripline conductor and the two fixed transmission line sections of phase shifting unit are in electrical transport relationship of spaced coupling, and there is air as spacer medium in the spaced coupling position.

6. The structure defined in claim 3, wherein the stripline conductor and the two fixed transmission line sections of phase shifting unit are in electrical transport relationship of spaced coupling, and there is insulating material in the spaced coupling position.

7. The structure defined in claim 1, wherein the stripline feeding network is formed of sheet metal fixed to the circuit layout surface of feed layer.

8. The structure defined in claim 1, wherein the feed layer is printed circuit board, the stripline feeding network is formed by etching.

9. The structure defined in claim 1, wherein said two metal layers are located in the corresponding position of back side of feed layer and in the corresponding position of circuit layout surface respectively.
